(19) United States
(12) Patent Application Publication
(10) Pub. No.: US 2007/0045400 A1
(43) Pub. Date: Mar. 1, 2007

(54) Distriubuted registry for personalization

(75) Inventors: Jason M. Brown, Durham, NC (US); Malcolm H. M. Holloway, Durham, NC (US); Sudhindra K. Rao, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/209,494

(22) Filed: Aug. 23, 2005

(51) Int. Cl. G06K 5/00

(52) U.S. Cl. 235/380

(57) ABSTRACT

Embodiments of the present invention address deficiencies of the art in respect to application personalization and provide a method, system and computer program product for application and computing environment personalization utilizing a distributed personalization data registry. In an embodiment of the invention, a personalization data processing system can include a service registry module client configured for disposition in a computing environment, a service registry module disposed remotely from the computing environment, and a personalization service coupled to the service registry module and enabled to process requests for personalization data from the service registry module client for a specified user within the computing environment.

### BACKGROUND OF THE INVENTION

1. Field of the Invention

The present invention relates to software environment configuration and more particularly to the personalization of a software environment.

2. Description of the Related Art

Oftentimes, utilizing computational resources requires both installation and configuration. Installation generally involves the transfer of program logic, program resource, and configuration files from storage media to an installation location. Configuration, in turn, involves the establishment of program or environment settings to enable the desired operation of the program logic within the chosen platform, possibly including the platform. Both installation and configuration can range from the installation and configuration of an application or platform from portable disk media as had traditionally been the case prior to the advent of the Internet, and more recently, to the installation and configuration of an application or platform from a networked source.

Personalization differs from installation and configuration in that personalization involves the tailoring of user preferences for interacting with an installed and configured application, or computing environment. While personalization most often is associated with the adjustment of a user interface to suit the personal preferences of a user, personalization can include many other utilitarian aspects of a computer program or environment, such as stored knowledge for the use including frequently provided information, and preferred locations for storing data. Notably, personalizing a software application or computing environment can be as difficult as installing and configuring the application or environment for use, regardless of the preferences of an end user.

Personalization settings are stored in one of two ways: In a first manner, personalization settings are stored within a computing device associated with the end user. Typically, the personalization settings are stored in a registry or as a separate file such as a cookie in the circumstance that the application to be personalized is a Web oriented application. In a second manner, personalization settings are stored remotely in a computing host. The latter manner of storing personalization settings can be helpful as when the end user accesses the application from different platforms, the personalization settings can follow the end user because the personalization settings are co-located with the application to which the settings apply.

Yet, many applications are not distributed in the manner that a Web application is distributed. Rather, most applications are hosted locally within a computing device associated with the end user. Thus, in a locally hosted application, as an end user changes from one host platform to the next, personalization will be required for each platform utilized by the user—a tedious process. Moreover, as updates to the personalization settings are applied, the updates must be individually applied to each other utilized platform—an even more tedious process.

### BRIEF SUMMARY OF THE INVENTION

Embodiments of the present invention address deficiencies of the art in respect to personalization and provide a novel and non-obvious method, system and apparatus for personalization utilizing a distributed personalization data registry. In an embodiment of the invention, a personalization data processing system can include a service registry module client configured for disposition in a computing platform, a service registry module disposed remotely from the computing platform, and a personalization service coupled to the service registry module and enabled to process requests for personalization data from the service registry module client for a specified user for an operating environment in the computing platform, or for an application invoked within the computing platform.

In another embodiment of the invention, a personalization method in a computing platform can include intercepting a request to invoke an application and identifying an end user associated with the request. Personalization data for the end user can be requested and received from a remotely disposed personalization service. In consequence, the application or the operating environment itself can be personalized using the personalization data. Specifically, personalizing the application or operating environment using the personalization data can include appending the personalization data to a local registry of personalization data disposed in the computing platform.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system configured to access a distributed registry for personalization;

FIG. 2 is a block diagram illustrating a systems architecture for a computing platform configured to access a distributed registry for personalization; and,

FIG. 3 is a flow chart illustrating a personalization process utilizing personalization settings from a distributed personalization registry.

### DETAILED DESCRIPTION OF THE INVENTION

Embodiments of the present invention provide a distributed personalization registry. In accordance with an embodiment of the present invention, personalization settings for an application or an operating environment can be stored in a distributed registry of personalization data and associated with a particular user. Service logic can be configured to communicate with communicatively coupled clients seeking access to the personalization data in the distributed registry. Accordingly, in response to an attempt to invoke an application in a computing platform by an end user, a request can be transmitted to the service logic over the computer communications network to retrieve the personalization data for the end user. Subsequently, the personalization data for the end user for the application can be provided for use in the computing platform in order to personalize the operating environment of the application, or the application itself, for the end user.

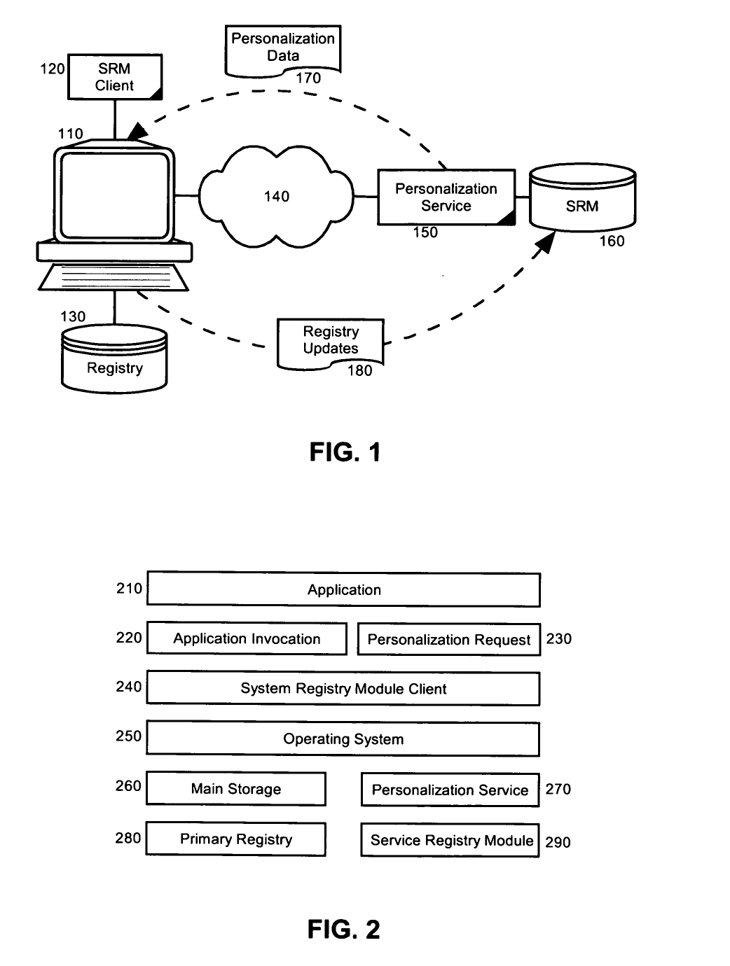

In more particular illustration, FIG. 1 is a schematic illustration of a system configured to access a distributed registry for personalization. The system can include a computing platform 110 configured to host the invocation and use of at least one application. In this regard, the computing platform 110 can include an operating environment and fixed storage and can range from a workstation to a pervasive device such as a personal digital assistant or mobile phone. The operating environment can be enabled to launch and manage the execution of one or more applications disposed in the fixed storage and can include a browser environment, operating system or virtual machine, to name only a few exemplary operating environments. The computing platform 110 also can include a local registry 130.

The registry 130 can store user interface settings for an application or an operating environment for the application which can range from user profile information to application execution parameters. For example, the registry 130 can store personalization information which can be used to personalize the presentation and operation of an application executing in the operating environment of the computing platform 110. Likewise, the registry 130 can store personalization information which can be used to personalize the presentation and operation of the operating environment within the computing platform 110.

Notably, the computing platform 110 can be configured for communicative coupling to at least one personalization service 150 over a computer communications network 140 including networks able to accommodate pervasive devices such as wireless devices like cellular telephones and handheld computing devices. The personalization service 150 can include program logic enabled to respond to requests to access a service registry module 160. For instance, the personalization service 150 can be a Web service which can be discovered through a request to a directory such as a universal data description, discovery and integration (UDDI) directory. Specifically, the service registry module 160 can include at least one set of personalization data 170 for a designated user (or class of users). Finally, a service registry module client 120 can be disposed in the computing platform 110.

The service registry module client 120, when activated, can intercept attempts to invoke an application hosted with the computing platform 110. In response to an attempt to invoke an application in the computing platform 110, the service registry module client 120 can request from the personalization service 150 that the personalization data 170 for a specified user or class of user, be provided for use in the computing platform 110. The personalization data 170 can include environmental and application preferences, as well as environmental and application configuration data.

In particular, the service registry module client 120 can append the personalization data 170 to the registry 130. Likewise, the service registry module client 120 can forward updates 180 to the personalization of the application to the personalization service 150 for incorporation in the service registry module 160. In this way, the application can remain personalized for the specified end user, irrespective of the particular computing platform 110 used to invoke the application. Notably, to synchronize or update the registry 130, an application programming interface can be provided at service registry client 120 to perform updates to the registry 130. In this case, the personalization service 150 can invoke the application programming interface provided at service registry client 120 and can send the personalization data 170 to the registry 130.

In further illustration, FIG. 2 is a block diagram illustrating a system architecture for a computing platform configured to access a distributed registry for personalization. As shown in FIG. 2, an operating system 250 configured with a service registry module client 240 can manage access to a primary registry of personalization data 280 in main storage 260, and also a service registry module 290 through the personalization service 270. Updates to the personalization data in the primary registry 280 can be provided to the service registry module 290. Likewise, the personalization data in the service registry module 290 can be used to update the primary registry 280.

The service registry module client 240 can be loaded into the computing device above or as part of the operating system 250. Subsequently, the service registry module client 240 can intercept or otherwise trap requests generated as part of the installation of the application 210. The personalization data for the installation of the application 210 can be recorded in the primary registry 280 in the course of installing the application 210. In consequence, the service registry module client 240 can update the service registry module 290 with the personalization information for the application 210 recorded in the primary registry 280.

The service registry module client 240 further can intercept or otherwise trap requests generated as part of an invocation process 220 for an application 210 or as part of a personalization request 230 to access the primary registry 280 on behalf of an application 210. In the course of handling requests generated as part of the invocation process 220, the system registry module client 240 through personalization services 270 can ensure that personalization information disposed in the service registry module 290 for a specified user is appended to the personalization information in the primary registry 280 so as to suitably personalize the environment of the application 210 for the specified user. Similarly, in the course of handling requests generated as part of a personalization request 230, the service registry module client 240 through personalization services 270 can ensure that personalization data associated with the application 210 is provided to the service registry module 290.

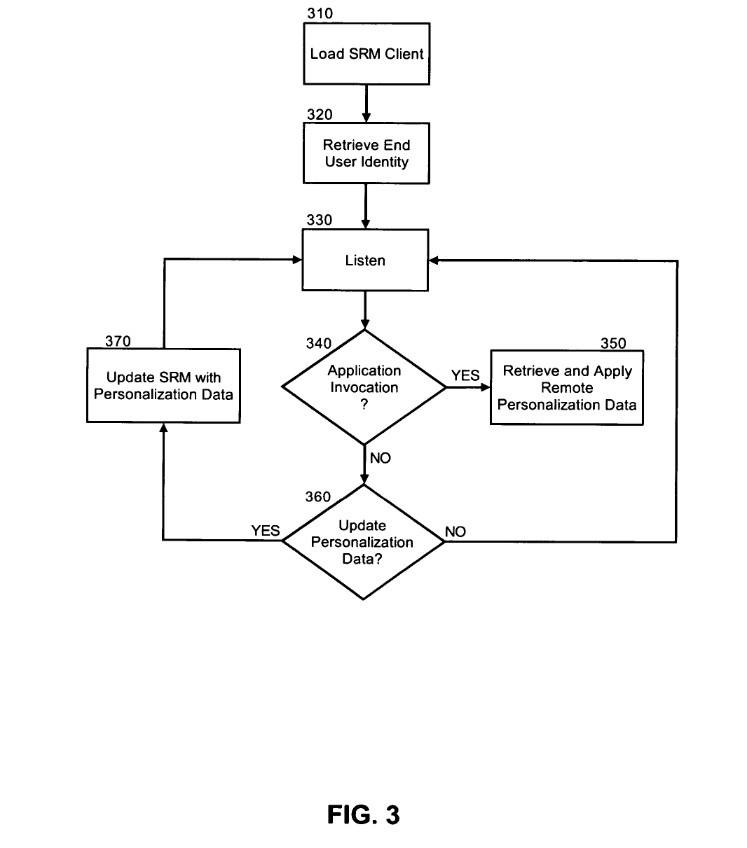

In further illustration, FIG. 3 is a flow chart illustrating a process for personalizing an application in a computing platform utilizing personalization settings from a distributed personalization registry. Beginning in block 310, a service registry module client can be loaded in the computing platform. In block 320, the identity of an end user can be determined for the computing platform. Subsequently, in block 330 the service registry module client can be enabled to listen for invocation requests and for personalization update requests in an invoked application.

In this regard, decision block 340, it can be determined whether an application has been invoked. If so, in block 350 the personalization data for the identified user can be retrieved from a remote, service registry module through a request to a personalization service over a communications network including computer communications networks enabled for use with pervasive devices. Once retrieved, the personalization data for the end user can be applied to the invoked application to configure the invoked application for use by the end user.

Returning to decision block 340, if an application has not been invoked, in decision block 360, it can be determined if personalization data for an already operating application in the computing platform has been updated. If so, the updated personalization data can be provided to the service registry module in block 370. In this way, the distributed personalization registry can maintain a current set of personalization data for the end user, irrespective of the computing platform used by the end user to interact with the application.

It will be recognized by the skilled artisan that the combination of the service registry module client and the remotely positioned service registry module permits global updates to personalization data in a centralized manner in that changes in the service registry module can propagate to different computing platforms over time. In this way, as organizational policies change in respect to the environment or application configuration, those organization policies can be applied or deployed in the context of an update to the service registry module without requiring manual updates to each computing platform.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A personalization data processing system comprising:
a service registry module client configured for disposition in a computing platform;
a service registry module disposed remotely from said computing platform; and,
a personalization service coupled to said service registry module and enabled to process requests for personalization data from said service registry module client for a specified user for said computing platform.

2. The data processing system of claim 1, wherein said personalization service is a Web service.

3. The data processing system of claim 1, wherein said personalization data comprises user interface configuration settings.

4. The data processing system of claim 1, wherein said personalization data comprises application personalization data.

5. The data processing system of claim 1, wherein said personalization data comprises computing environment personalization data.

6. A personalization method comprising:
identifying an end user interacting with a computing environment;
requesting and receiving personalization data for said end user from a remotely disposed personalization service; and,
personalizing said computing environment using said personalization data.

7. The method of claim 6, further comprising:
intercepting a request to apply updates to said personalization data;
identifying an end user associated with said request; and,
providing said updates to said remotely disposed personalization service.

8. The method of claim 6, wherein said requesting and receiving personalization data for said end user from a remotely disposed personalization service comprises:
discovering said personalization service in a remotely disposed directory;
forwarding said request to said discovered personalization service; and,
receiving in response to said request, said personalization data for said end user.

9. The method of claim 6, wherein said personalizing said computing environment using said personalization data comprises personalizing an application invoked within said computing environment using said personalization data.

10. The method of claim 6, wherein said personalizing said computing environment using said personalization data comprises personalizing an operating environment for said computing environment using said personalization data.

11. The method of claim 6, wherein said personalizing said application using said personalization data comprises appending said personalization data to a local registry of personalization data in said computing environment.

12. A computer program product comprising a computer usable medium having computer usable program code for personalization, said computer program product including:
computer usable program code for identifying an end user interacting with a computing environment;
computer usable program code for requesting and receiving personalization data for said end user from a remotely disposed personalization service; and,
computer usable program code for personalizing said computing environment using said personalization data.

13. The computer program product of claim 12, further comprising:
computer usable program code for intercepting a request to apply updates to said personalization data;
computer usable program code for identifying an end user associated with said request; and,
computer usable program code for providing said updates to said remotely disposed personalization service.

14. The computer program product of claim 12, wherein said computer usable program code for requesting and receiving personalization data for said end user from a remotely disposed personalization service comprises:
computer usable program code for discovering said personalization service in a remotely disposed directory;
computer usable program code for forwarding said request to said discovered personalization service; and,
computer usable program code for receiving in response to said request, said personalization data for said end user.

15. The computer program product of claim 12, wherein said computer usable program code for personalizing said computing environment using said personalization data comprises personalizing an application invoked within an operating environment in said computing environment using said personalization data.

16. The computer program product of claim 12, wherein said computer usable program code for personalizing said computing environment using said personalization data comprises personalizing an operating environment for said computing environment using said personalization data.

17. The computer program product of claim 12, wherein said computer usable program code for personalizing said computing environment using said personalization data comprises computer usable program code for appending said personalization data to a local registry of personalization data in said computing environment.

18. A personalization method comprising:
installing a service registry module client in a computing environment;
configuring a service registry module remotely from said computing environment; and,
enabling a personalization service coupled to said service registry to process requests for personalization data from said service registry module client for a specified user for said computing environment.

19. The method of claim 18, wherein said personalization data comprises personalization data selected from the group consisting of application personalization data and environment personalization data.

20. The method of claim 18, wherein said personalization data comprises a policy configured for one of enforcement and deployment in said computing environment.
